(19) United States
(12) Patent Application Publication
(10) Pub. No.: US 2025/0206335 A1
(43) Pub. Date: Jun. 26, 2025

(54) METHOD AND DEVICE WITH PATH GENERATION

(71) Applicant: Samsung Electronics Co., Ltd., Suwon-si (KR)

(72) Inventors: Younghwa JUNG, Suwon-si (KR); Jaeseok CHOI, Suwon-si (KR)

(73) Assignee: Samsung Electronics Co., Ltd., Suwon-si (KR)

(21) Appl. No.: 18/754,904

(22) Filed: Jun. 26, 2024

(30) Foreign Application Priority Data
Dec. 21, 2023 (KR) 10-2023-0188723

(51) Int. Cl. B60W 60/00; G05B 13/02

(52) U.S. Cl. CPC B60W 60/001; G05B 13/027; B60W 2556/00; B60W 2756/00

(57) ABSTRACT

A processor-implemented method with path generation includes obtaining input data that includes recognition sensor data and state data, inputting the input data into an artificial neural network (ANN) model and outputting output data corresponding to the input data in a single forward process, and obtaining path data and control data corresponding to the path data, based on the output data.

### CROSS-REFERENCE TO RELATED APPLICATIONS

This application claims the benefit under 35 USC § 119 (a) of Korean Patent Application No. 10-2023-0188723, filed on Dec. 21, 2023 in the Korean Intellectual Property Office, the entire disclosure of which is incorporated herein by reference for all purposes.

### BACKGROUND

### 1. Field

The following description relates to a method and device with path generation.

### 2. Description of Related Art

Self-driving domestic robots, industrial robots, and vehicles may be used in various places such as homes, offices, and public places.

An autonomous driving device may proactively make a path plan in order to generate a driving path. In the typical case, the path plan may be made through a sampling-based algorithm, but the sampling-based algorithm may have issues of slow convergence speed, large memory requirements, and path generation delay in narrow passages.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with path generation includes obtaining input data that includes recognition sensor data and state data, inputting the input data into an artificial neural network (ANN) model and outputting output data corresponding to the input data in a single forward process, and obtaining path data and control data corresponding to the path data, based on the output data.

The outputting of the output data may include inputting the input data into the ANN model and outputting the output data including a plurality of output elements respectively corresponding to a plurality of prediction timestamps.

The obtaining of the control data may include obtaining steering data corresponding to the path data, and obtaining acceleration data corresponding to the path data.

The outputting of the output data may include inputting the input data into the ANN model and outputting quaternion data corresponding to the input data.

The outputting of the output data may include inputting the input data into the ANN model and outputting dual quaternion data corresponding to the input data.

The obtaining of the path data and the control data corresponding to the path data may include obtaining the path data based on coordinates of dual quaternion elements included in the dual quaternion data, obtaining steering data corresponding to the path data based on a rotation transformation operation between the dual quaternion elements, and obtaining acceleration data corresponding to the path data based on a translation transformation operation between the dual quaternion elements.

The obtaining of the path data based on the coordinates of the dual quaternion elements may include obtaining path data between the coordinates of the dual quaternion elements through an interpolation operation.

The method may include inputting the input data into an encoder and obtaining feature data corresponding to the input data, wherein the outputting of the output data may include inputting the feature data into the ANN model and outputting the output data corresponding to the feature data.

The obtaining of the feature data may include inputting the recognition sensor data into a first encoder and obtaining first feature data corresponding to the recognition sensor data, and inputting the state data into a second encoder and obtaining second feature data corresponding to the state data.

The obtaining of the input data may include obtaining the recognition sensor data including either one or both of image data and light detection and ranging (LiDAR) data, and obtaining the state data including any one or any combination of any two or more of speed data, direction data, and acceleration information of an autonomous driving device.

In one or more general aspects, a non-transitory computer-readable storage medium may store instructions that, when executed by one or more processors, configure the one or more processors to any one, any combination, or all of operations and/or methods disclosed herein.

In one or more general aspects, an electronic device includes one or more processors configured to obtain input data that includes recognition sensor data and state data, input the input data into an artificial neural network (ANN) model and output output data corresponding to the input data in a single forward process, and obtain path data and control data corresponding to the path data, based on the output data.

For the outputting of the output data, the one or more processors may be configured to input the input data into the ANN model and output the output data including a plurality of output elements respectively corresponding to each of a plurality of prediction timestamps.

For the obtaining of the control data, the one or more processors may be configured to obtain steering data corresponding to the path data, and

obtain acceleration data corresponding to the path data.

For the outputting of the output data, the one or more processors may be configured to input the input data into the ANN model and output quaternion data corresponding to the input data.

For the outputting of the output data, the one or more processors may be configured to input the input data into the ANN model and output dual quaternion data corresponding to the input data.

For the obtaining of the path data and the control data corresponding to the path data, the one or more processors may be configured to obtain the path data based on coordinates of dual quaternion elements included in the dual quaternion data, obtain steering data corresponding to the path data based on a rotation transformation operation between the dual quaternion elements, and obtain acceleration data corresponding to the path data based on a translation transformation operation between the dual quaternion elements.

For the obtaining of the path data based on the coordinates of the dual quaternion elements, the one or more processors may be configured to obtain path data between the coordinates of the dual quaternion elements through an interpolation operation.

The one or more processors may be configured to input the input data into an encoder and obtain feature data corresponding to the input data, and for the outputting of the output data, input the feature data into the ANN model and output the output data corresponding to the feature data.

In one or more general aspects, a processor-implemented method with path generation includes obtaining input data that includes recognition sensor data and state data, generating, by inputting the input data into an artificial neural network (ANN) model in a single forward process, a plurality of dual quaternion elements each corresponding to a respective timestamp, and obtaining path data, steering data, and acceleration data by performing respective operations between the dual quaternion elements.

Other features and aspects will be apparent from the following detailed description, the drawings, and the claims.

### BRIEF DESCRIPTION OF THE DRAWINGS

FIGS. 1A and 1B illustrate examples of a path generation method for autonomous driving.

FIG. 2A illustrates an example of a deep learning operation method using an artificial neural network (ANN).

FIG. 2B illustrates an example of a training and inference method of an ANN model.

FIG. 3 illustrates an example of a quaternion.

FIG. 4 illustrates an example of a configuration of an electronic device.

FIGS. 5A to 5C illustrate examples of a path generation method.

FIG. 6 illustrates an example of a data generation method.

FIG. 7 illustrates an example of a training method.

FIG. 8 illustrates an example of an inference method.

FIG. 9 illustrates an example of a technical effect of a path generation method.

FIG. 10 illustrates an example of a training method framework.

FIG. 11 illustrates an example of a path generation method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The examples may be implemented as various types of products such as, for example, a personal computer, a laptop computer, a tablet computer, a smart phone, a television, a smart home appliance, an intelligent vehicle, a kiosk, and/or a wearable device. Hereinafter, examples will be described in detail with reference to the accompanying drawings. In the drawings, like reference numerals are used for like elements.

An artificial intelligence (AI) system is a computer system and a system that enables a machine to learn and judge and become smart, unlike typical rule-based systems. As the AI system is used more, the AI system has an improved recognition rate and more accurately understands the preference of a user. Thus, the typical rule-based systems may be replaced with deep learning-based AI systems.

AI technology includes machine learning (deep learning) and element techniques that utilize machine learning.

Machine learning is algorithm technology that classifies/learns features of input data, and element techniques are techniques that use machine learning algorithms, such as deep learning, and include technical fields, such as linguistic understanding, visual understanding, inference/prediction, knowledge representation, and motion control.

Linguistic understanding is a technique of recognizing and applying/processing human language/characters and includes natural language processing, machine translation, dialogue system, question and answer, and speech recognition/synthesis. Visual understanding is a technique of recognizing and processing objects like human vision and includes object recognition, object tracking, image retrieval, person recognition, scene understanding, spatial understanding, and image enhancement. Inference/prediction is a technique of judging information and performing logical inference and prediction and includes knowledge/probability-based inference, optimization prediction, preference-based planning, and recommendation. Knowledge representation is a technique of automatically processing human experience information into knowledge data and includes knowledge construction (data generation/classification) and knowledge management (e.g., data utilization). Motion control is a technique of controlling autonomous driving of a vehicle and movement of a robot and includes movement control (e.g., navigation, collision, driving, etc.) and operation control (e.g., action control).

The disclosed examples describe a method of generating a path for an autonomous vehicle to drive without collision in an autonomous driving system and a device for performing the method, which are described in detail below with reference to the attached drawings.

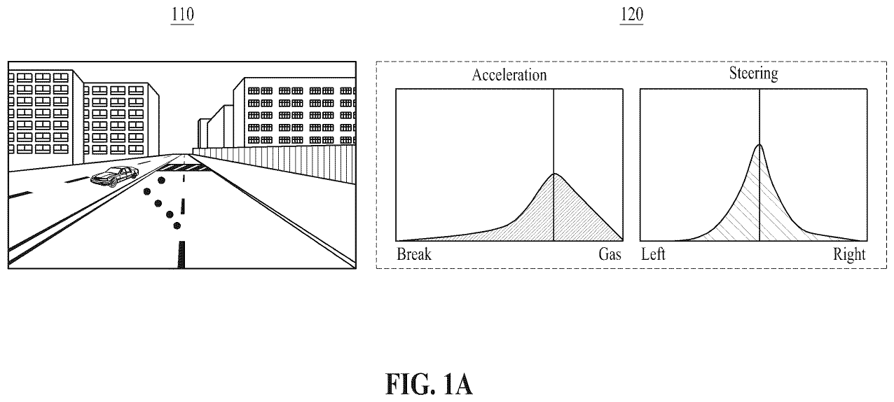

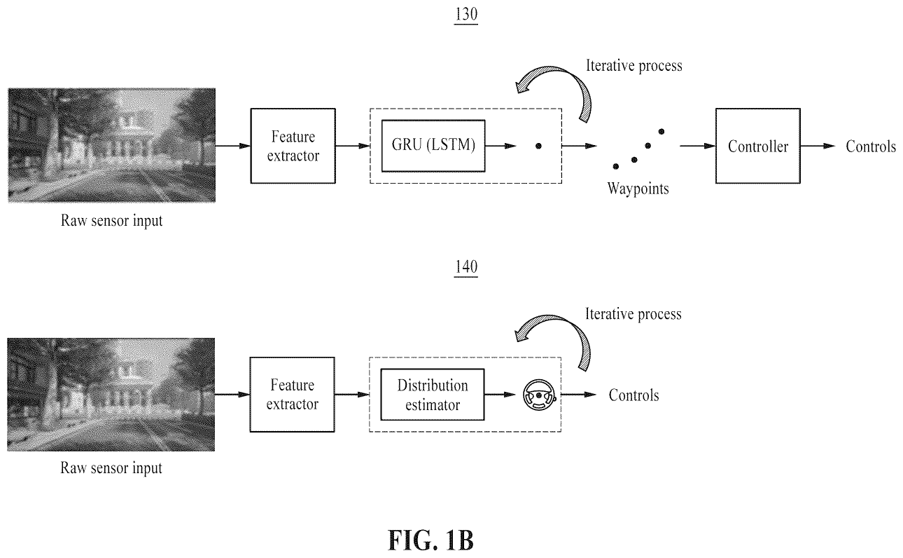

FIGS. 1A and 1B illustrate examples of a path generation method for autonomous driving.

An autonomous driving device refers to a device for autonomous driving without intervention of a driver. An autonomous driving device may be implemented in a vehicle but is not necessarily limited thereto and may be implemented in various vehicles such as two-wheeled vehicles, robots, and flying vehicles. For ease of description, in the present specification, an autonomous driving device is shown and described assuming that the autonomous driving device is implemented as a vehicle.

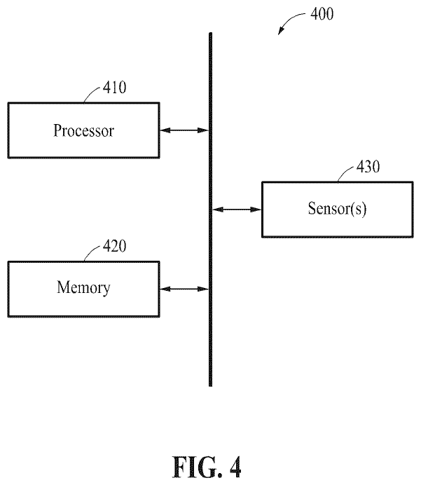

An autonomous driving device may drive in an autonomous mode depending on a recognized driving environment. The driving environment may be recognized through one or more sensors (e.g., sensor(s) 430 of FIG. 4) attached to or installed in the autonomous driving device. For example, the one or more sensors may include a camera, a light detection and ranging (LiDAR) sensor, a radar, voice recognition sensors, and/or an inertial measurement unit (IMU) sensor but are not limited thereto. The driving environment may include a road, the conditions of the road, the type of lane line, the presence or absence of a nearby vehicle, a distance to a nearby vehicle, the weather, the presence or absence of an obstacle, and the like but is not limited thereto.

The autonomous driving device may recognize the driving environment and may generate a driving path appropriate for the driving environment. The autonomous driving device may control internal and external mechanical elements to follow the driving path. The autonomous driving device may periodically generate an autonomous driving path.

For example, the autonomous driving device may generate path data and control data to generate an autonomous driving path. The path data may be data about a path that the autonomous driving device needs to follow, and the control data may be data about a control value in order to follow the path.

According to typical technology, the autonomous driving device may generate the path data first and may then generate the control data based on the generated path data. For example, referring to diagram 110, the autonomous driving device may generate the path data in the form of waypoints. Subsequently, the autonomous driving device may then obtain the control data (e.g., acceleration data and steering data) using a control device, such as a math-based proportional-integral-derivative (PID) controller, in order to follow the path.

According to other typical technology, the autonomous driving device may predict the control data directly without separately obtaining the path data (e.g., waypoints). For example, referring to diagram 120, the autonomous driving device may immediately predict acceleration data and steering data based on data obtained from the sensors.

Referring to FIG. 1B, there are various methods of obtaining both path data and control data through neural networks.

For example, diagram 130 illustrates an example of a typical technique of predicting path data using a neural network and then determining control data using a controller. Referring to diagram 130, an autonomous driving device may input raw sensor input data, such as image data and LiDAR data obtained from sensors, into a convolutional network to extract feature data about a surrounding situation and may input the feature data into a neural network used to predict consecutive values, such as a gated recurrent unit (GRU) or a long short-term memory (LSTM), to obtain the path data. Due to the characteristics of the neural network used to obtain the path data (e.g., the GRU or LSTM), the autonomous driving device may predict the path data iteratively. Subsequently, as described above, the autonomous driving device may use the controller to obtain the control data corresponding to the path data.

In the case of a typical technique in which the path data is predicted using a neural network, the GRU or LSTM may be used to predict points corresponding to each discrete timestamp, waypoints are generated for a specific time, and then the control data is obtained using the controller described above. However, when this typical method is used, a process of obtaining a hyper-parameter of the controller may be additionally required in order to obtain a feasible control value. Furthermore, since the typical method only considers predicting path waypoints without considering the control data during training, there may also be a case in which waypoints are generated that may not be reached by control.

Diagram 140 illustrates an example of a typical technique of immediately predicting control data using a neural network. Referring to diagram 140, an autonomous driving device may input raw sensor input data, such as image data and LiDAR data obtained from sensors, into a convolutional network to extract feature data about a surrounding situation and may input the feature data into a neural network widely used to predict consecutive values, such as a GRU or an LSTM, to obtain the control data. Similarly, the autonomous driving device may predict the control data iteratively.

When this method is used, the controller may not be used to obtain the control data, since the control data is output immediately. Therefore, this method may not need a process of hyperparameter tuning of the controller. However, since this typical method requires no collision at the initial timestamp in order to reduce errors of the control data at each timestamp during training, the training may be performed where matching a control value of the initial timestamp is heavily weighted. Therefore, performance of predicting the control value is bound to deteriorate toward a second half. Particularly, since acceleration in the control data is proportional to a distance to the square of time due to the characteristics of acceleration, this typical method is bound to increase errors in estimating waypoints.

Since the path data and the control data have a correlation, it may be inefficient to separately predict each piece of data. There is typical technology of estimating the path data and the control data at the same time using a neural network, but this typical technology separately generates and executes a network branch that is in charge of the path data and the control data.

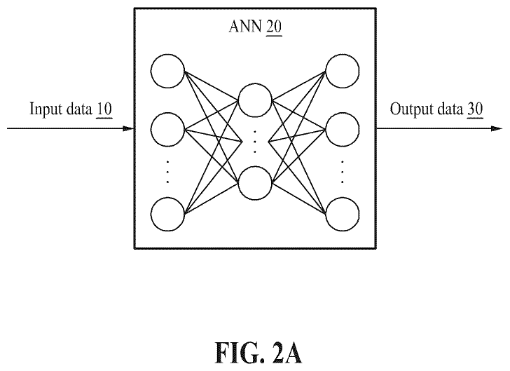

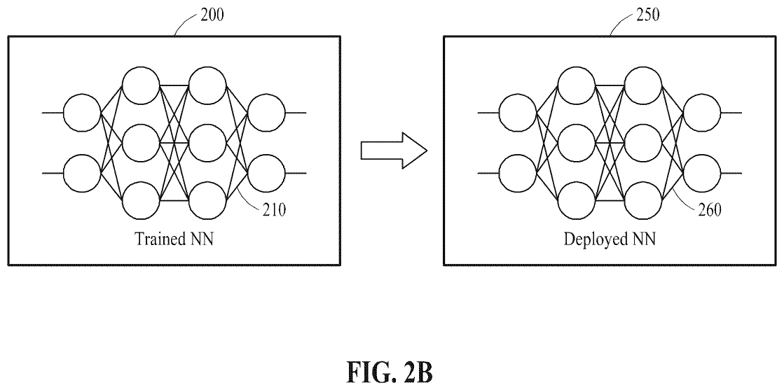

As described in detail below, unlike the typical technologies described above, a path generation method of one or more embodiments may output output data in a form that may simultaneously express the path data and the control data in one network. For example, the path generation method of one or more embodiments may use quaternion data as a representation to represent the path data and the control data at the same time. Before describing the path generation method, an AI algorithm is described with reference to FIGS. 2A and 2B.

FIG. 2A illustrates an example of a deep learning operation method using an artificial neural network (ANN).

An AI algorithm including deep learning or the like may input input data 10 to an ANN 20 and may learn output data 30 through an operation such as a convolution. The ANN 20 may be a computational architecture obtained. In the ANN 20, nodes may be connected to each other and may collectively operate to process input data. The ANN 20 may include, for example, a feed-forward neural network, a deep neural network (DNN), a convolutional neural network (CNN), a recurrent neural network (RNN), a deep belief network (DBN), and/or a restricted Boltzmann machine (RBM) but are not limited thereto. In the feed-forward neural network, nodes of the neural network may have links to other nodes, and the links may be expanded in one direction, for example, a forward direction, through the neural network.

The ANN 20 (e.g., a CNN) may include one or more layers and the output data 30 may be output through the ANN 20. The ANN 20 may be, for example, a DNN including at least two layers.

The CNN may be used to extract “features”, for example, a border or a line color, from the input data 10. The CNN may include a plurality of layers. Each of the layers may receive data, may process data input to a corresponding layer, and may generate data that is to be output from the corresponding layer. The data output from the layer may be a feature map generated by performing a convolution operation of an image or a feature map that is input to the CNN with weight values of at least one filter. Initial layers of the CNN may operate to extract features of a low level, such as edges or gradients, from an input. Subsequent layers of the CNN may gradually extract more complex features, such as the eyes and nose in an image.

FIG. 2B illustrates an example of a training and inference method of an ANN model.

Referring to FIG. 2B, a path generation system may include a training device 200 and an inference device 250. The training device 200 may correspond to a computing device having various processing functions, such as generating a neural network, training (or learning) a neural network, and/or retraining a neural network. For example, the training device 200 may be implemented as various types of devices, such as a personal computer (PC), a server device, a mobile device, and the like.

The training device 200 may generate at least one trained neural network 210 by repetitively training (or learning) a given initial neural network. The generating of the at least one trained neural network 210 may include determining neural network parameters. The parameters may include various types of data (for example, input/output activations, weights, and/or biases of a neural network) that are input to and output from the neural network. As the neural network is repeatedly trained, the parameters of the neural network may be tuned to generate a more accurate output for a given input.

The training device 200 may transmit the at least one trained neural network 210 to the inference device 250. The inference device 250 may be or be included in, for example, a mobile device and/or an embedded device. The inference device 250 may be dedicated hardware for driving a neural network and may be an electronic device including at least one of a processor, memory, an input/output (I/O) interface, a display, a communication interface, and/or a sensor.

The inference device 250 may be or include any digital device that includes a memory element and a microprocessor and has an operational capability, such as a tablet PC, a smartphone, a PC (e.g., a notebook computer), an AI speaker, a smart TV, a mobile phone, a navigation system, a web pad, a personal digital assistant (PDA), a workstation, and the like.

The inference device 250 may drive the at least one trained neural network 210 without a change thereto or may drive a neural network 260 obtained by processing (for example, quantizing) the at least one trained neural network 210. The inference device 250 for driving the neural network 260 may be implemented in a separate device from the training device 200. However, examples are not limited thereto. The inference device 250 may also be implemented in the same device as the training device 200. For example, the inference device 250 may include the training device 200, or the training device 200 may include the inference device 250.

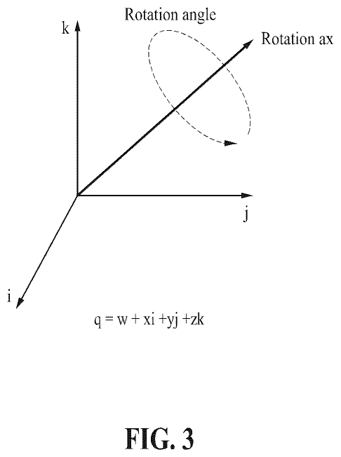

FIG. 3 illustrates an example of a quaternion.

Referring to FIG. 3, a quaternion is a vector in a four-dimensional complex space, as shown in Equation 1 below, for example.

$$q = 〈 w , x , y , z 〉 = w + ai + bj + ck \qquad Equation 1$$

In Equation 1, w denotes a scalar value and x, y, and z correspond to parts of a vector. When representing rotation, a rotation axis may be interpreted as w representing a rotation value as <x,y,z> and i, j, and k are specific virtual unit vectors.

Furthermore, a path generation method may represent output data through a dual quaternion. A dual quaternion is a combination of two quaternions, which may include a basic quaternion part and a dual quaternion part. The basic quaternion part may represent rotation and the dual quaternion part may represent movement. The dual quaternion is shown as Equation 2 below, for example.

$${q}_{r} + {q}_{d} ϵ , ϵ \neq 0 , {ϵ}^{2} = 0 \qquad Equation 2$$

In Equation 2, qᵣ denotes the basic quaternion part representing rotation and q_{d} denotes the dual quaternion part, which satisfies

$${q}_{d} = \frac{1}{2} {tq}_{r} .$$

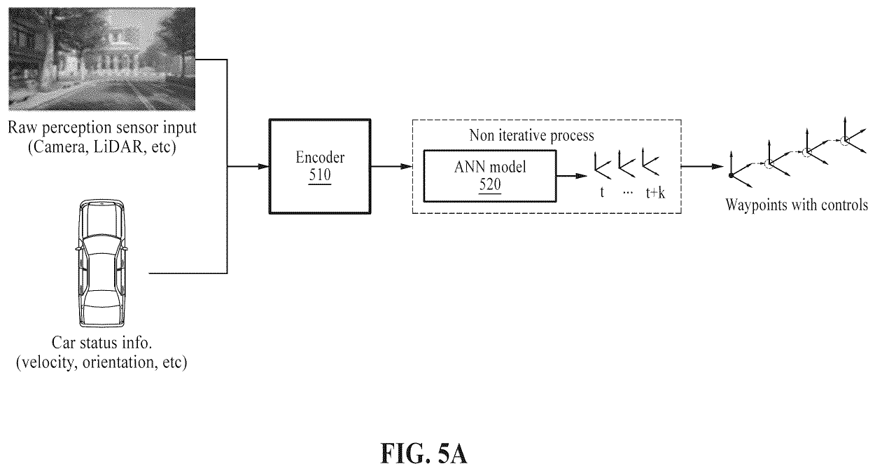

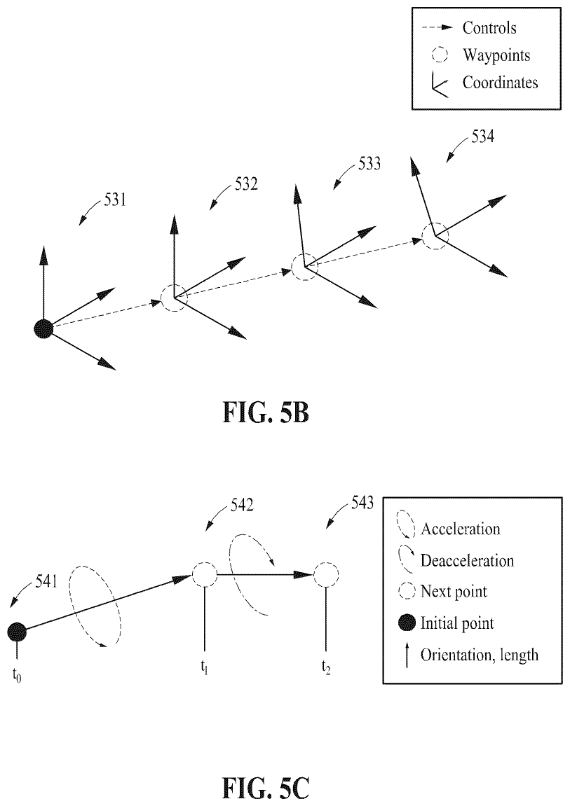

t denotes a quaternion describing movement represented by a vector t=(0, tₓ, t_{y}, t_{z}). The dual quaternion is a compact form that may represent a rigid transform and is free from a singularity issue that may occur in an affine matrix operation. In addition, when interpolating between two coordinates, an operation may be easily performed using the shortest path, and therefore, a value between waypoints may be easily obtained. An example method of obtaining path data and control data from output data represented as quaternion data or dual quaternion data is described in detail below with reference to FIGS. 5A to 5C.

FIG. 4 illustrates an example of a configuration of an electronic device.

Referring to FIG. 4, an electronic device 400 may include a processor 410 (e.g., one or more processors), a memory 420 (e.g., one or more memories), and sensor(s) 430 (e.g., one or more sensors). The description provided with reference to FIGS. 2A to 3 may also apply to FIG. 4. For example, the training device 200 and/or the inference device 250 described with reference to FIG. 2B may be, or be included in, the electronic device 400 of FIG. 4. Furthermore, the electronic device 400 may be an autonomous driving device, such as a driverless car, an autonomous vehicle, robot, and a drone, a mobile communication device, and/or an Internet of Things device.

The memory 420 may store computer-readable instructions. When the instructions stored in the memory 420 are executed by the processor 410, the processor 410 may process operations defined by the instructions. For example, the memory 420 may include a non-transitory computer-readable storage medium storing instructions that, when executed the processor 410, configure the processor 410 to perform any one, any combination, or all of operations and/or methods disclosed herein with reference to FIGS. 1-11. The memory 420 may include, for example, random-access memory (RAM), dynamic random-access memory (DRAM), static random-access memory (SRAM), and/or other types of non-volatile memory known in the art. The memory 420 may store a pre-trained ANN model.

For example, the sensor(s) 430 may include cameras, LiDAR sensors, radars, voice recognition sensor, and IMU sensors but are not limited thereto. Since one skilled in the art may intuitively infer a function of each sensor from its name, a detailed description thereof is omitted.

The at least one processor 410 may control the overall operation of the electronic device 400. The processor 410 may be a hardware-implemented device having a circuit that is physically structured to execute desired operations. The desired operations may include code or instructions in a program. The hardware-implemented device may include, but is not limited to, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

The processor 410 may control the electronic device 400 by executing functions and instructions for execution in the electronic device 400.

By the control of the processor 410, the electronic device 400 may input input data into an ANN model, may output output data corresponding to the input data in a single forward process, and, based on the output data, may obtain path data and control data corresponding to the path data.

FIGS. 5A to 5C illustrate examples of a path generation method. The description provided with reference to FIGS. 2A to 4 may also apply to FIGS. 5A to 5C.

Referring to FIG. 5A, an electronic device (e.g., the electronic device 400 of FIG. 4) may include an encoder 510 and an ANN model 520. The encoder 510 may be referred to as a feature extractor and the ANN model 520 may be referred to as a quaternion estimator. In addition, the encoder 510 and the ANN model 520 may be divided based on processing functions or operations, and both the encoder 510 and the ANN model 520 may be implemented with the processor 410 described with reference to FIG. 4.

The electronic device may obtain input data including recognition sensor data and state data. The recognition sensor data is data that may be obtained through a recognition sensor and may include information about the outside of the electronic device (e.g., a driving environment). The state data may refer to information about the electronic device (e.g., speed, direction, and acceleration of an autonomous driving device). For example, the electronic device may obtain the recognition sensor data from a recognition sensor (e.g., a LIDAR sensor and/or a camera). In addition, the electronic device may obtain the state data (e.g., vehicle state information such as vehicle speed and direction obtained from a vehicle controller area network (CAN) signal) from a state sensor (e.g., an IMU).

The encoder 510 may receive the input data and may output feature data corresponding to the input data. The feature data corresponding to the recognition sensor data may be data about features that abstract information about the driving environment, and the feature data corresponding to the state data may be data about features that abstract information about the state of the electronic device (e.g., an autonomous driving device).

The recognition sensor data and the state data may be input to the encoder 510, which is the same single encoder. For example, the encoder 510 may output the feature data corresponding to the recognition sensor data and the feature data corresponding to the state data.

Alternatively, the encoder 510 may include a first encoder and a second encoder and the recognition sensor data and the state data may be input to different encoders among the first encoder and the second encoder. For example, the encoder 510 may include a first encoder (e.g., a CNN-based encoder) and a second encoder (e.g., a multilayer perceptron (MLP)-based encoder), the feature data corresponding to the recognition sensor data may be output from the first encoder, and the feature data corresponding to the state data may be output from the second encoder.

The ANN model 520 may receive the feature data and may output output data corresponding to the feature data. When the ANN model 520 is not configured as a neural network (e.g., RNN, GRU, LSTM) that predicts time series data, the ANN model 520 may not operate iteratively and may output the output data in a single forward pass. For example, the ANN model 520 may output output data including a plurality of output elements respectively corresponding to a plurality of prediction timestamps. For example, the output data may include output elements corresponding to prediction timestamps at predetermined time intervals (e.g., 4 seconds). The number of prediction timestamps may be predetermined (e.g., “10”). The output data may be expressed as quaternion data or dual quaternion data. Each of the output elements included in the output data may be represented as the quaternion data or dual quaternion data.

The electronic device may obtain path data and control data corresponding to the path data based on the output data. Since the output data is defined such that the path data and the control data may be represented simultaneously, the electronic device may obtain the path data and the control data (e.g., steering data and/or acceleration data) corresponding to the path data from a single piece of the output data.

Referring to FIG. 5B, the output data may be represented as dual quaternion data. The output data may include output elements 532 to 534 represented by three pieces of dual quaternion data.

The electronic device may obtain dual quaternion data 531 corresponding to the initial position of the electronic device at a current time point (t=0). The electronic device may determine a waypoint corresponding to each of the output elements 532 to 534, based on the dual quaternion data 531 corresponding to the initial position and a dual quaternion part of the output elements 532 to 534.

For example, when the electronic device recognizes coordinates of the dual quaternion data 531 corresponding to the initial position, the coordinates of the dual quaternion data 531 and the dual quaternion part (e.g., q_{d} of Equation 2) indicating the degree of movement of the output element 532 may be used to determine the waypoint corresponding to the output element 532.

Furthermore, the electronic device may obtain steering data corresponding to the path data based on a rotation transformation operation between the output elements 532 to 534. The basic quaternion part (e.g., qᵣ of Equation 2) of the dual quaternion data 531 may include rotation information. Therefore, the electronic device may perform the rotation transformation operation between the output element 532 and the output element 533, may determine an angle between the rotational axis of the output element 532 and the rotational axis of the output element 533, and may obtain steering data based on the angle obtained through the determination.

Furthermore, the electronic device may obtain acceleration data corresponding to the path data based on a translation transformation operation between dual quaternion elements. Since the prediction timestamp may have a predetermined time interval and may determine the waypoint corresponding to each of the output elements 532 to 534, the electronic device may determine the acceleration data by using the time interval of the prediction timestamp and waypoints obtained through the translation transformation.

Referring to FIG. 5C, the output data may be represented as single quaternion data. The output data may include output elements 542 to 543 represented by two pieces of single quaternion data.

The electronic device may obtain single quaternion data 541 corresponding to the initial position of the electronic device at a current time point (t=0). When coordinates of the single quaternion data 541 are (x₀, y₀, z₀) and the quaternion of the output element 542 is q=w+ai+bj+ck, the waypoint of the output element 542 may be determined as shown in Equation 3 below, for example.

$$( {x}_{1} , {y}_{1} , {z}_{1} ) = ( {x}_{0} + a , {y}_{0} + b , {z}_{0} + c ) \qquad Equation 3$$

Furthermore, the electronic device may determine an angle between the rotational axis of the output element 542 and the rotational axis of the output element 543 and may obtain steering data based on the angle obtained through the determination.

Furthermore, in the case of a unit quaternion, using a range between −1 and 1, the closer to +1 may be defined as the maximum acceleration and the closer to −1 may be defined as the maximum break. The electronic device may obtain acceleration data corresponding to each of the output element 542 and the output element 543 based on the defined values.

An affine matrix may also be used to perform coordinate transformation. However, dual quaternion may need only “8” values to express the transformation, and therefore, memory requirements may be relatively less than that of the affine matrix (4×4), which requires “16” values. For example, when the same coordinate transformation operation is performed, the dual quaternion may perform the operation 10 percent (%) faster than the affine matrix. Furthermore, even when a multiplication operation is performed, the dual quaternion requires fewer operations than the affine matrix.

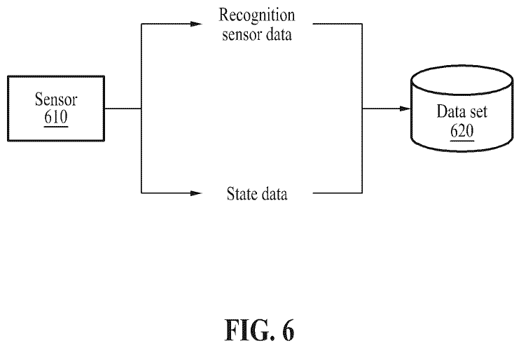

FIG. 6 illustrates an example of a data generation method. The description provided with reference to FIGS. 2A to 5C may also apply to FIG. 6.

Referring to FIG. 6, a sensor 610 (e.g., the sensor(s) 430 of FIG. 4) may obtain training data for training an ANN (e.g., the ANN model 520 of FIG. 5A).

For example, an expert may drive a mobility device (e.g., a vehicle) equipped with a recognition sensor, such as a camera or LiDAR sensor, and the sensor 610 for identifying vehicle information to obtain recognition sensor data and state information data. The obtained recognition sensor data and state information data may be stored as a data set 620 for training.

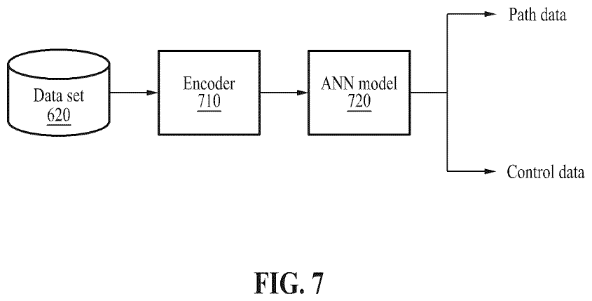

FIG. 7 illustrates an example of a training method. The description provided with reference to FIGS. 2A to 6 may also apply to FIG. 7.

Referring to FIG. 7, a training device (e.g., the training device 200 of FIG. 2A) may learn an encoder 710 and an ANN model 720 based on the data set 620. The encoder 710 and the ANN model 720 may be trained on an end-to-end basis, and therefore, separately obtained data may not need to be manually labelled. The data set 620 (recognition sensor data and state information data obtained by a sensor through driving) may be used as input data for training and at the same time as ground truth data.

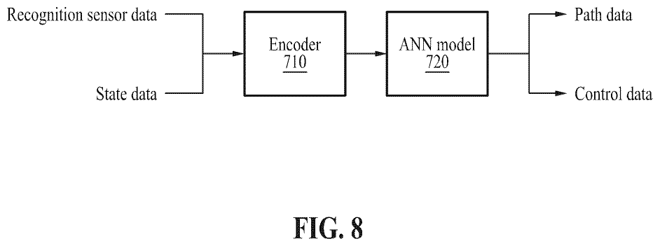

FIG. 8 illustrates an example of an inference method. The description provided with reference to FIGS. 2A to 7 may also apply to FIG. 8.

Referring to FIG. 8, an electronic device (e.g., the electronic device 400 of FIG. 4) may generate path data and control data corresponding to input data using a trained encoder 710 and a trained ANN model 720.

The electronic device may estimate in real time a path (e.g., the path data) in which an autonomous driving device is to move for a predetermined period of time by avoiding obstacles, such as dynamic objects, and control information (e.g., the control data), by which the autonomous driving device is to move according to the path, using recognition sensor data and state information data.

For example, the electronic device may obtain the recognition sensor data and the state information data and may input the recognition sensor data and the state information data into the trained encoder 710 to obtain feature data. The electronic device may input the feature data into the trained ANN model 720 to obtain output data (e.g., output data represented as dual quaternion) and may obtain the recognition sensor data and the state information data based on the output data.

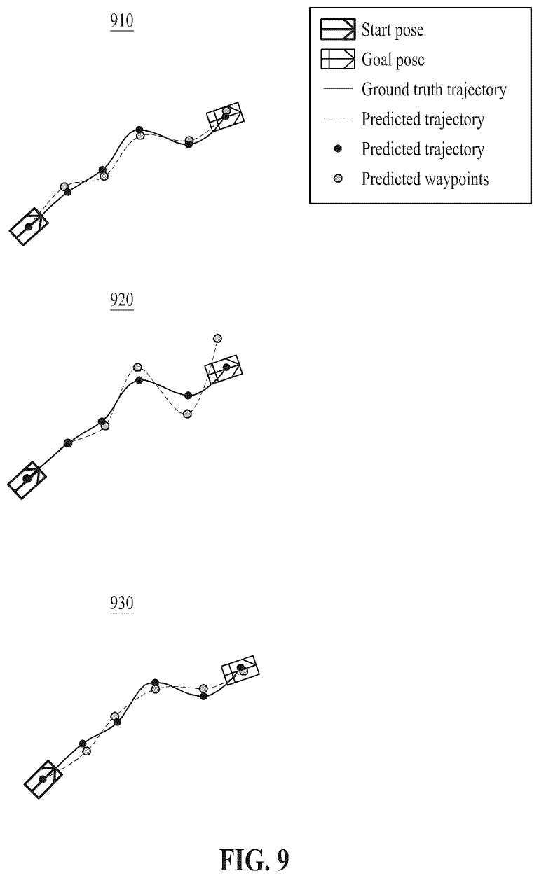

FIG. 9 illustrates an example of a technical effect of a path generation method. The description provided with reference to FIGS. 2A to 8 may also apply to FIG. 9.

Referring to FIG. 9, a typical method 910 of estimating only a path without simultaneously estimating the path and a control value may predict waypoints similar to ground truth for all timestamps. However, there may be disadvantages in typical method 910 in that a controller is required to obtain control data and a process of separately tuning hyperparameters of the controller is necessary to obtain optimal control data.

A typical method 920 of directly estimating the control data may not require separate tuning of the hyperparameters of the controller, but the performance of estimating waypoints through the typical method 920 may be inevitably lower than a method of directly estimating waypoints. This is because, in the typical method 920 of directly estimating the control data, an ANN model may be trained to reduce the difference with ground truth action, rather than to reduce a distance error from ground truth waypoints. Therefore, since there needs to be no collision at the initial timestamp, training may be performed such that matching the control data of the initial timestamp is greatly weighted. Accordingly, in the typical method 920 of directly estimating the control data, accuracy of the control data may be bound to decrease toward the latter part of the prediction. Particularly, since acceleration in the control data affects distance in proportion to the square of time, in the typical method 920 of directly estimating the control data, errors may inevitably increase in terms of estimating the waypoints.

Unlike the typical method 910, a path generation method 930 of one or more embodiments may not require a traditional controller, since an implemented network is trained to simultaneously produces the corresponding waypoints and the control data as the final output, during training. Therefore, the path generation method 930 of one or more embodiments may also not require the process of tuning hyperparameters of the controller.

Furthermore, unlike the typical method 920, the path generation method 930 of one or more embodiments may have a regularization effect that prevents the control data from being heavily weighted on nearby timestamps, since the path generation method 930 of one or more embodiments considers the waypoints and the control data at the same time during training. Since the distance between points is considered, the path generation method 930 of one or more embodiments may better consider in which direction and how much the movement may occur when a certain control value is provided.

The path generation method 930 of one or more embodiments may use recognition sensor data and state information data received through sensors equipped in an autonomous driving device in real time as an input to an end-to-end network and may output, in the form of a quaternion (or dual quaternion), the control data and the waypoints in which the autonomous driving device needs to be driven forward in real time. Since the quaternion has a faster operation speed than a matrix and occupies less memory, the quaternion may be suitable for autonomous driving algorithms that need a real time guarantee.

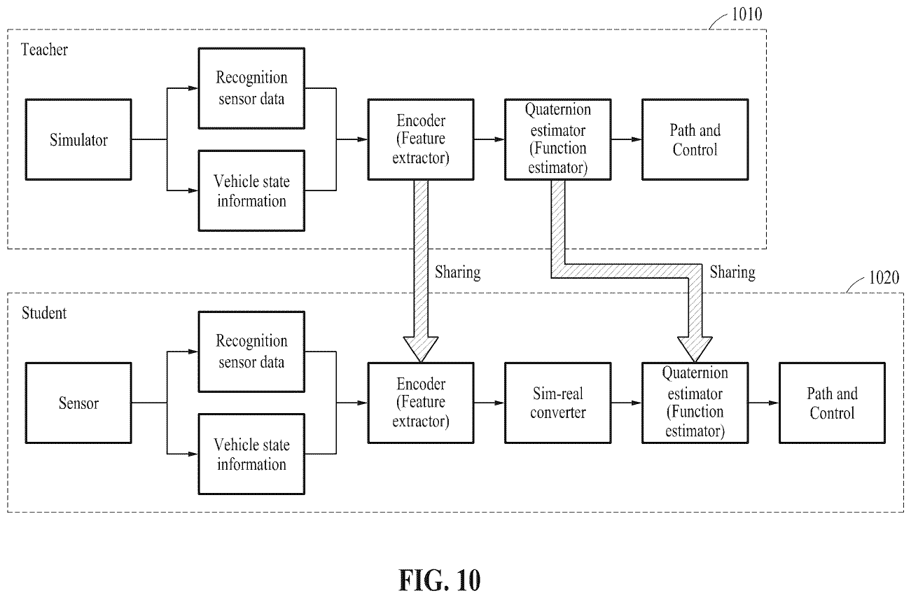

FIG. 10 illustrates an example of a training method framework.

Referring to FIG. 10, a training device (e.g., the training device 200 of FIG. 2B) may also use a teacher-student framework to train an ANN model.

For autonomous driving, it may be difficult for a typical training device to obtain a variety of real-world driving data. However, when an autonomous driving simulator is used, large amounts of data about various situations may be obtained relatively easily.

Therefore, in a teacher model 1010, the training device of one or more embodiments may use the data obtained from a simulator to train an encoder and the ANN model. The encoder and the ANN model trained in the teacher model 1010 may be shared with a student model 1020.

The training of the student model 1020 may be performed based on data obtained from the real world rather than from a simulation. However, when there is a domain gap between the simulator and the real world, the inference performance of the student model 1020 may be reduced. Accordingly, the student model 1020 of one or more embodiments may further include a converter that makes a feature from the encoder similar to a feature from the simulator. The converter may be trained based on data obtained from the real world.

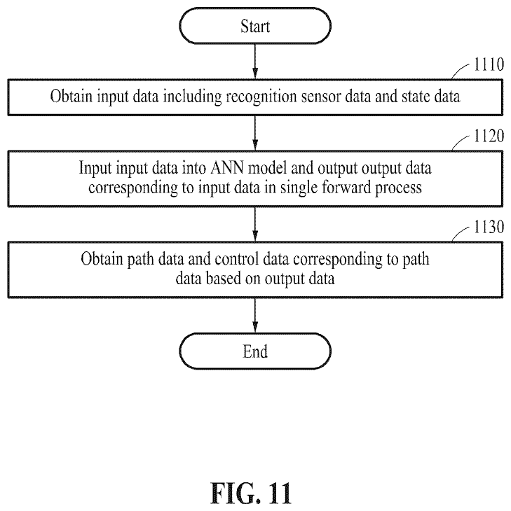

FIG. 11 illustrates an example of a path generation method.

For ease of description, operations 1110 to 1130 are described as being performed by the electronic device 400 illustrated in FIG. 4. However, operations 1110 to 1130 may be performed by another suitable electronic device in a suitable system.

Furthermore, the operations of FIG. 11 may be performed in the shown order and manner. However, the order of one or more of the operations may be changed, two or more of the operations may be performed in parallel or simultaneously, and/or one or more of the operations may be omitted without departing from the spirit and scope of the shown example.

In operation 1110, the electronic device 400 may obtain input data including recognition sensor data and state data. The electronic device 400 may obtain the recognition sensor data including at least one of image data and LiDAR data and may obtain the state data including at least one of speed data, direction data, and acceleration information of an autonomous driving device.

In operation 1120, the electronic device 400 may input the input data into an ANN model and may output output data corresponding to the input data in a single forward process. The electronic device 400 may input the input data into the ANN model and may output the output data including a plurality of output elements respectively corresponding to a plurality of prediction timestamps.

The electronic device 400 may input the input data into the ANN model and may output quaternion data corresponding to the input data. Alternatively, the electronic device 400 may input the input data into the ANN model and may output dual quaternion data corresponding to the input data.

In operation 1130, the electronic device 400 may obtain path data and control data corresponding to the path data based on the output data. The electronic device 400 may obtain steering data corresponding to the path data and acceleration data corresponding to the path data.

The electronic device 400 may acquire the path data based on coordinates of dual quaternion elements included in the dual quaternion data, may obtain the steering data corresponding to the path data based on a rotation transformation operation between the dual quaternion elements, and may obtain the acceleration data corresponding to the path data based on a translation transformation operation between the dual quaternion elements. The electronic device 400 may obtain the path data between the coordinates of the dual quaternion elements through an interpolation operation.

The electronic device 400 may input the input data into an encoder to obtain feature data corresponding to the input data and may input the feature data into the ANN model to output the output data corresponding to the feature data.

The electronic device 400 may input the recognition sensor data into a first encoder to obtain a first piece of the feature data corresponding to the recognition sensor data and may input the state data into a second encoder to obtain a second piece of the feature data corresponding to the state data.

The electronic devices, processors, memories, sensors, encoders, electronic device 400, processor 410, memory 420, sensor(s) 430, encoder 510, sensor 610, and encoder 710 described herein, including descriptions with respect to respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-11 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto—optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with path generation, the method comprising:
obtaining input data that includes recognition sensor data and state data;
inputting the input data into an artificial neural network (ANN) model and outputting output data corresponding to the input data in a single forward process; and
obtaining path data and control data corresponding to the path data, based on the output data.

2. The method of claim 1, wherein the outputting of the output data comprises inputting the input data into the ANN model and outputting the output data including a plurality of output elements respectively corresponding to a plurality of prediction timestamps.

3. The method of claim 1, wherein the obtaining of the control data comprises:
obtaining steering data corresponding to the path data; and
obtaining acceleration data corresponding to the path data.

4. The method of claim 1, wherein the outputting of the output data comprises inputting the input data into the ANN model and outputting quaternion data corresponding to the input data.

5. The method of claim 1, wherein the outputting of the output data comprises inputting the input data into the ANN model and outputting dual quaternion data corresponding to the input data.

6. The method of claim 5, wherein the obtaining of the path data and the control data corresponding to the path data comprises:
obtaining the path data based on coordinates of dual quaternion elements included in the dual quaternion data;
obtaining steering data corresponding to the path data based on a rotation transformation operation between the dual quaternion elements; and
obtaining acceleration data corresponding to the path data based on a translation transformation operation between the dual quaternion elements.

7. The method of claim 6, wherein the obtaining of the path data based on the coordinates of the dual quaternion elements comprises obtaining path data between the coordinates of the dual quaternion elements through an interpolation operation.

8. The method of claim 1, further comprising:
inputting the input data into an encoder and obtaining feature data corresponding to the input data,
wherein the outputting of the output data comprises inputting the feature data into the ANN model and outputting the output data corresponding to the feature data.

9. The method of claim 8, wherein the obtaining of the feature data comprises:
inputting the recognition sensor data into a first encoder and obtaining first feature data corresponding to the recognition sensor data; and
inputting the state data into a second encoder and obtaining second feature data corresponding to the state data.

10. The method of claim 1, wherein the obtaining of the input data comprises:
obtaining the recognition sensor data including either one or both of image data and light detection and ranging (LiDAR) data; and
obtaining the state data including any one or any combination of any two or more of speed data, direction data, and acceleration information of an autonomous driving device.

11. A non-transitory computer-readable storage medium storing instructions that, when executed by one or more processors, configure the one or more processors to perform the method of claim 1.

12. An electronic device comprising:
one or more processors configured to:
obtain input data that includes recognition sensor data and state data;
input the input data into an artificial neural network (ANN) model and output output data corresponding to the input data in a single forward process; and
obtain path data and control data corresponding to the path data, based on the output data.

13. The electronic device of claim 12, wherein, for the outputting of the output data, the one or more processors are further configured to input the input data into the ANN model and output the output data including a plurality of output elements respectively corresponding to each of a plurality of prediction timestamps.

14. The electronic device of claim 12, wherein, for the obtaining of the control data, the one or more processors are further configured to:
obtain steering data corresponding to the path data; and
obtain acceleration data corresponding to the path data.

15. The electronic device of claim 12, wherein, for the outputting of the output data, the one or more processors are further configured to input the input data into the ANN model and output quaternion data corresponding to the input data.

16. The electronic device of claim 12, wherein, for the outputting of the output data, the one or more processors are further configured to input the input data into the ANN model and output dual quaternion data corresponding to the input data.

17. The electronic device of claim 16, wherein, for the obtaining of the path data and the control data corresponding to the path data, the one or more processors are further configured to:
obtain the path data based on coordinates of dual quaternion elements included in the dual quaternion data;
obtain steering data corresponding to the path data based on a rotation transformation operation between the dual quaternion elements; and
obtain acceleration data corresponding to the path data based on a translation transformation operation between the dual quaternion elements.

18. The electronic device of claim 17, wherein, for the obtaining of the path data based on the coordinates of the dual quaternion elements, the one or more processors are further configured to obtain path data between the coordinates of the dual quaternion elements through an interpolation operation.

19. The electronic device of claim 12, wherein the one or more processors are further configured to:
input the input data into an encoder and obtain feature data corresponding to the input data; and
for the outputting of the output data, input the feature data into the ANN model and output the output data corresponding to the feature data.

20. A processor-implemented method with path generation, the method comprising:
obtaining input data that includes recognition sensor data and state data;
generating, by inputting the input data into an artificial neural network (ANN) model in a single forward process, a plurality of dual quaternion elements each corresponding to a respective timestamp; and
obtaining path data, steering data, and acceleration data by performing respective operations between the dual quaternion elements.
